(19) United States
(12) Patent Application Publication
(10) Pub. No.: US 2011/0250011 A1
(43) Pub. Date: Oct. 13, 2011

(54) POSITIVE CONNECTING DEVICE FOR TWO COMPONENTS, PARTICULARLY SOLAR MODULES

(75) Inventor: Sascha Oliver Schwarze, Berlin (DE)

(73) Assignee: SOLON SE, Berlin (DE)

(21) Appl. No.: 13/080,790

(22) Filed: Apr. 6, 2011

(30) Foreign Application Priority Data
Apr. 8, 2010 (DE) 10 2010 014 414

(51) Int. Cl. F16B 17/00

(52) U.S. Cl. 403/294

(57) ABSTRACT

A positive connecting device for connecting components includes a first connecting profile disposed on a first component and a second connecting profile disposed on a second component opposite the first connecting profile in a connected state of the connecting device. Each connecting profile includes an upper profile strip and a lower profile strip. Each of the upper and lower profile strips includes undercuts. A connecting element including undercuts that are complementary to the undercuts of the first and second connecting profiles is pressed between connecting profiles in the connected state of the connecting device. The upper and lower profile strips of the connecting profiles are configured as individual profile segments that are spaced apart from one another in a longitudinal direction of the connecting device with a spacing that is at least as wide as the profile segments such that the profile segments of the upper profile strips are disposed in a non-overlapping arrangement with the profile segments of the lower profile strips in the longitudinal direction.

### CROSS-REFERENCE TO PRIOR APPLICATIONS

Priority is claimed to German Patent Application No. DE 10 2010 014 414, filed on Apr. 8, 2010, the entire disclosure of which is hereby incorporated by reference herein.

### FIELD

The invention relates generally to a positive connecting device for two components, and especially to a connecting device for solar modules.

### BACKGROUND

Positive connecting devices are used for the rapid, simple and releasable, yet secure connection of two components with one another, for example two panel-shaped solar modules or cladding panels. In this case, the positive connecting device can be part of a frame or a mounting frame of the components. At the same time, the connecting device can be used for connecting the components to a substrate.

A positive connection can be performed if the components to be connected in each case have connecting profiles with complementary undercuts. To this end, both components are then pushed into one another directly using the complementary undercuts of their connecting profiles without a connecting element. In order to avoid the associated movement of the whole, if appropriate large and heavy, panel-shaped components against one another, and the risk of tilting, the components can also be brought into the correct position and, without moving them further, their connecting profiles can be connected using a rod-shaped connecting element, the connecting element having the undercuts complementary to the undercuts on the connecting profiles of the components on both sides. This connection technology also allows the removal of individual components from a composite of many components arranged in the area in multiple rows and multiple columns, in that only the connecting elements to the adjacent components have to be pulled and the desired component can then be lifted out of the assembly. For mounting the connecting device, the connecting profiles of the two components have to be brought parallel to one another at such a spacing that the connecting element can be pushed into the undercuts of the connecting profile using its complementary undercuts. After the pushing in, both components form a positive and non-positive stable composite, produced by means of the connecting device, which can only be released again by removing the connecting element.

A connecting device for solar modules is described in DE 20 2007 007 976 U1, which connects two components by means of connecting profiles arranged on supports and with undercuts, into which a short connecting element with complementary undercuts engages. To this end, the connecting element is inserted into the connecting profile, the components pushed thereon and the components, the connecting element and the connecting profiles are clamped together using a centrally arranged screw, the head of which overlaps the edges of both components. The system is dependent on the supports with the integrated connecting profiles connected to the roof structure and therefore does not have a solitary connecting element for the two components. The supports are realised as metallic extruded profiles on account of their extent and required dimensional stability, the connecting elements by contrast are realised as plastic castings. Dimensional stability of the composite of the components is not provided by the connecting device. A positive fit between the elements of the connecting device and the components also does not result. For a mechanically stable connection of the components to the support, a plurality of the connecting devices must be used on each side of the components.

A connecting sleeve is described in EP 1 662 630 B1, in the case of which, the connection of two components, here the half shells of the connecting sleeve, takes place with the aid of a connecting device made up of four connecting profiles with two profile strips having undercuts in each case and four connecting elements with complementary undercuts. The four connecting elements are placed on the connecting profiles at both ends of the connecting sleeve composed of the two half shells, on the left and on the right in each case over the separating gaps of the half shells for their fixing. To this end, they are realised in a conical manner, so that they can be pushed in very easily in the case of the attachment and lead towards the end of the movement to a positive and non-positive and self-adhering connection of the half shells. In the case of the connection described, there is no common connecting element for connecting the two half shells; rather, four identical connecting elements are required. These are located outside of the half shells. The half shells and connecting elements have only a small longitudinal extent and can be produced with simple removability from the mold due to their shaping by means of plastic casting process, but a connection extending over the entire length of extended components cannot be produced using this connecting device.

For a photovoltaic plant with a matrix made up of frameless solar modules, a connecting device for connecting the solar modules is described in DE 10 2007 056 600 A1, which connecting device produces the cohesion by means of connecting profiles with upper and lower profile strips with undercuts in the longitudinal direction and a common connecting element with complementary undercuts. In this case, the respective upper profile strip is a shape component of an upper connecting profile arranged on the solar module and the respectively lower profile strip is a shape component of a lower connecting profile arranged such that it lies on the building structure. For connection, a connecting element is pushed over the profile strips of the connecting profiles. In this case, there is a divided connecting element made up of two identical rails which in each case connect the two lower and the two upper profile strips. The stable positive fit is produced by means of screws which clamp the two rails to one another. The shape of the connecting profiles and the rails of the divided connecting element are unsuitable for a cost-effective plastic casting process.

DE 20 2006 003 925 U1 describes a generic positive connecting device for two components, particularly solar modules, with a first connecting profile and a further connecting profile, which is opposite the latter in the connected state of the connecting device, which connecting profiles are assigned to one component in each case and have an upper profile strip and a lower profile strip with undercuts, into which, in the connected state, a connecting element with undercuts complementary to the undercuts is pushed.

Described therein is a connecting device, in the case of which the connection of two components takes place with a common connecting element which has complementary undercuts which can be inserted in a displaceable manner in undercuts of profile strips of the connecting profiles of the components. For producing the positive and non-positive fit, the connecting element has central nuts on both sides, which are screwed against the components following the mounting and ensure a positive connection. The described connecting device is provided for fence posts and possesses only a small extent for forming the two central threads. In the case of a larger extent in the thickness without central nuts, a simple production with a cost-effective plastic casting process is not possible on account of the problem of the very complex removal from the mold of undercuts in long casting molds.

### SUMMARY

In an embodiment, the present invention provides a positive connecting device for connecting components. The connecting device includes a first connecting profile disposed on a first component and a second connecting profile disposed on a second component opposite the first connecting profile in a connected state of the connecting device. Each connecting profile includes an upper profile strip and a lower profile strip. Each of the upper and lower profile strips includes undercuts. A connecting element including undercuts that are complementary to the undercuts of the first and second connecting profiles is pressed between connecting profiles in the connected state of the connecting device. The upper and lower profile strips of the connecting profiles are configured as individual profile segments that are spaced apart from one another in a longitudinal direction of the connecting device with a spacing that is at least as wide as the profile segments such that the profile segments of the upper profile strips are disposed in a non-overlapping arrangement with the profile segments of the lower profile strips in the longitudinal direction.

### BRIEF DESCRIPTION OF THE DRAWINGS

The present invention will be described in even greater detail below based on embodiments of the positive connecting device for two components shown in the exemplary, schematic figures. The invention is not limited to the exemplary embodiments. Other features and advantages of various embodiments of the present invention will become apparent by reading the following detailed description with reference to the attached drawings which illustrate the following:

FIG. 1 shows a cross section through a prior art positive connecting device,

FIG. 2 shows a first embodiment of the connecting device according to the present invention with short profile segments in a connected perspective illustration,

FIG. 3 shows a projection view in a longitudinal direction of the connecting device from above onto the first connecting profile from FIG. 2,

FIG. 4 shows another embodiment with profile segments with webs in an open perspective illustration,

FIG. 5 shows the embodiment from FIG. 4 in a connected perspective illustration,

FIG. 6 shows a projection view in a longitudinal direction of the connecting device from the front onto the embodiment from the FIGS. 4 and 5,

FIG. 7 shows a further embodiment with profile segments on webs with guide pins in an open perspective illustration,

FIG. 8 shows a projection view in a longitudinal direction of the connecting device from the front onto an embodiment with a transposition of the profile segments with the webs,

FIG. 9 shows a perspective illustration of the connecting element with oblique dividing plane and

FIG. 10 shows a perspective illustration of the one connecting profile with a mold parting line.

### DETAILED DESCRIPTION

In an embodiment, the present invention provides a generic positive connecting device for two components, which, while retaining the known advantages mentioned, particularly dimensional stability over the entire length of the components to be connected, and also rapid, secure and simple mounting and unmounting, can be produced in a cost-effective manner in spite of this, particularly in a plastic casting method.

In an embodiment, the present invention provides a positive connecting device for solar modules, with a first connecting profile and a further connecting profile, which is opposite the latter in the connected state of the connecting device, which connecting profiles are assigned to one component in each case and have an upper profile strip and a lower profile strip with undercuts, into which, in the connected state, a connecting element with undercuts complementary to the undercuts is pushed.

In an embodiment of the present invention, the profile strips are divided into individual profile segments which are arranged with a spacing from one another. The spacings are in each case just as wide as or wider than the profile segments. Each profile segment of the upper profile strip is arranged opposite a spacing in the lower profile strip and each profile segment of the lower profile strip is arranged opposite a spacing in the upper profile strip. In the projection view in each case of the upper profile strip to the lower profile strip, their profile segments as a result appear such that they lie next to one another without any overlap, if the spacings and the profile segments are of exactly the same width. In the case of spacings which are wider than the profile segments, in the projection view of the upper to the lower profile strip, the profile segments now appear such that they lie next to one another with gaps.

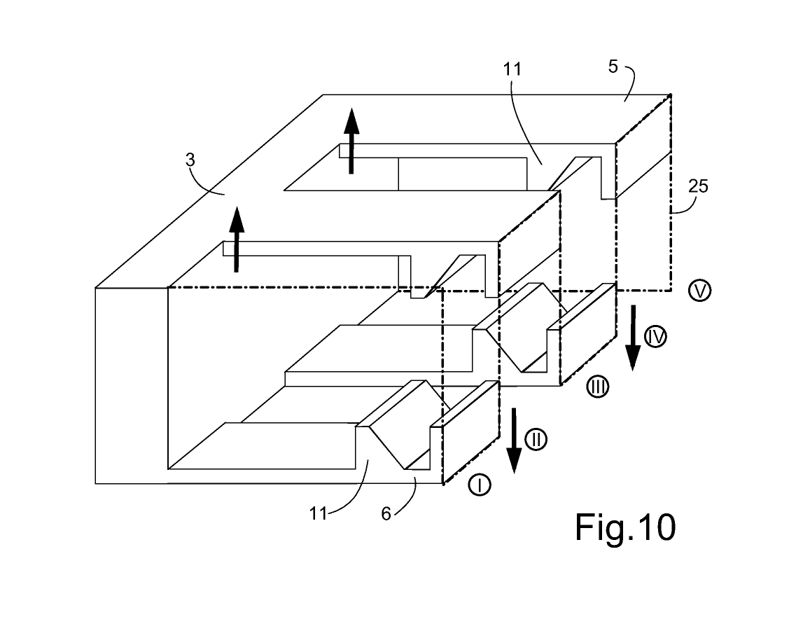

Machining, extrusion or casting processes are considered fundamentally for producing the profile strips with undercuts. For reasons of cost, machining production methods will only be used in special cases. With the extrusion process, connecting profiles can be made from metal with the corresponding weight. For production from light plastic, the injection molding process is considered, in the case of which, the undercuts of profile strips described in the prior art present particular problems in the design of the mold cavity. For removing undercuts from the mold, the mold box must have complicated partitions which may, if appropriate, cause burrs which must be removed in an expensive manner. In the case of the use of sliders in the mold, which can form the undercuts, problems are caused by the mold inclines, which prevent the dimensional stability which is required running along the entire length of the profile strips. For the mass production of connecting profiles for the positive connecting device according to an embodiment of the present invention, only a single two-part mold cavity without sliders or other auxiliary devices is provided, by contrast, for the injection molding process. The division of the profile strips into profile segments with spacings, each profile segment of the upper profile strip being arranged opposite a spacing in the lower profile strip and each profile segment of the lower profile strip being arranged opposite a spacing in the upper profile strip and the profile segments of both profile strips appearing opposite one another without overlap in the projection view, avoids undercuts to be cast and thus enables the construction of a simple divided mold cavity. To this end, the negative shape in the interior of the mold divided between the upper and the lower profile strip is divided up in a meandering fashion in such a manner that the upper profile segments are molded in lower mold half and the lower profile segments are molded in the upper mold half. The associated undercuts then no longer hinder the removal from the mold. Further details to this end are to be drawn from FIG. 10 and the associated description thereof.

In the case of the fundamental configuration of the positive connecting device for two components according to an embodiment of the present invention with regards to a simple removability from the mold in the case of a plastic casting process, only the arrangement without overlap of the profile segments in the projection view of the upper to the lower profile strip is required. The profile segments of the mutually opposite upper and lower profile segments can therefore overlap with respect to each other completely or partially in the projection view, they do not engage in one another in a meshing manner in this first basic embodiment. Due to a non-overlapping arrangement of the respectively upper profile strips and the lower profile strips in the projection view of both connecting profiles with respect to each other in the connected state of the connecting device, the profile segments can engage in one another in a meshing manner and, by means of an arrangement of orthogonal webs of the same length at the location of the profile segments, a preferred configuration of the positive connecting device for two components according to an embodiment of the present invention is enabled. In this case, either the profile segments are arranged at the front sides of the webs or the webs are arranged at the front sides of the profile segments and the end faces of the profile segments or the webs form stops for the spacing apart of the two connecting profiles in the connected state. In the case of a forming of the connecting profiles without webs, the components for producing the connection on the not completely even substrates do not have to be brought into an exact position opposite one another and held in position during the complete process of the pushing in of the connecting element. The required spacing in the case of the pushing together of the two components is produced and held over the entire length by means of webs of the same length at the locations of the profile segments. In addition, displacements in the longitudinal direction against each other are avoided by means of the mesh-like toothing in the case of the gapless configuration. The connection process can now be carried out in a simple manner by a fitter. Further advantageous for the production process is the configuration of the webs and profile segments in the same width and a one-piece construction of each profile segment with the associated web and/or each web or profile segment with the associated connecting profile and/or each connecting profile with the associated component. The production is further simplified by means of a configuration of the connecting profiles as a common casting.

The positive connecting device for two components according to an embodiment of the present invention is advantageously developed by means of a guide pin on the end face of each profile segment or web, which guide pin engages into a guide opening in the region of the stop on the respectively opposite connecting profile in the connected state of the connecting device. Following engagement in their guide openings, the guide pins prevent a hitherto still possible vertical displacement, and in the case of spacings which are wider than the profile segments, also a displacement of the two components against one another in the longitudinal direction of the connection, due to which displacement the insertion of the connecting element would be made more difficult. With the pins, an offset of this type is no longer possible.

Preferred embodiments are also achieved by means of an equally wide construction of all profile segments and an equally wide construction of all spacings and, building thereon, a construction of identical shape of the two connecting profiles. The producibility in the same shape provides for symmetrically constructed connecting profiles. As a result, the overall costs are reduced. A construction in the manner of a doubled dovetail connection is a possible variant of the undercuts of the profile strips.

Furthermore, preferred configurations of the positive connecting device for two components according to embodiments of the present invention result by means of a division in two of the connecting element in the region of a central dividing plane in the longitudinal direction of the connecting device into an upper connecting body and a lower connecting body, which in the connected state of the connecting device have reverse sides which adjoin one another in the dividing plane, by means of an obliquely running dividing plane of the connecting element and also by means of a construction of identical shape of the two connecting bodies. The pushing in of the connecting element during the connection of the connecting profiles for achieving a positive and non-positive, stable and force-absorbing connection of two components becomes more and more difficult with the progress of the pushing in, due to increasing frictional forces in the case of the shape extended in terms of length. In an embodiment where the use of a heavy tool should be avoided and a simple connecting method is a goal, the division of the connecting element by means of an oblique central dividing plane is provided. The oblique dividing plane ensures an upper and a lower connecting body which are both constructed in a thicker manner at one end and in a thinner manner at the other end than the average in the case of a planar division. In the procedure of the connection, the lower connecting body can be pushed simply and without great resistance with the thicker end first into the lower profile segments. If the upper connecting body is then pushed with the thinner end first into the upper profile segments, then this is possible as long as there is little or no resistance, such as the two connecting bodies not touching at their reverse sides. If this is the case towards the end of the pushing-in movement, the frictional force will increase, so that only the last end of the connection must be closed as far as complete overlapping of both connecting bodies with overcoming of friction. The non-positive and self-locking connection of both connecting bodies ensures a play-free clamping of the connecting device, which therefore securely prevents the displacement of the connected components in all three dimensions.

For fixing the formations formed with the aid of the connecting device for two components according to an embodiment of the present invention to the substrate, open or closed eyelets can advantageously be arranged at the ends of the connecting element, into which tensioning cables can be guided. Only a few anchor points are required for anchoring the tensioning cables against lifting off of the components in the case of wind suction, which anchor points additionally can lie at the edges of the building and, in an embodiment, do not penetrate the roof covering.

Particularly advantageous developments of the positive connecting device for two components according to the invention are achieved by means of a construction of the connecting profiles and/or the connecting element as material-saving hollow profiles and by means of a realisation of the connecting profile and/or the connecting element in plastic injection molding. The basic constructive embodiment of the connecting device presented here is optimized for production in an injection mold.

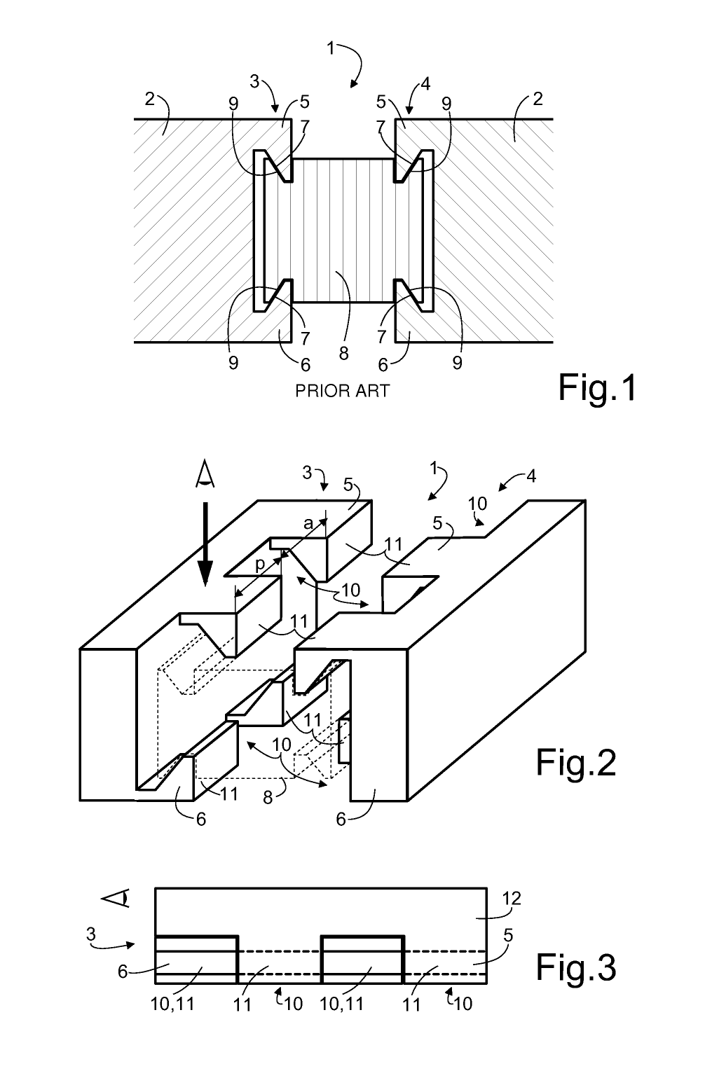

FIG. 1 shows a cross section through a positive connecting device 1 for two components 2 from the prior art, with a first connecting profile 3 and a further connecting profile 4, which is opposite the latter in the connected state, which connecting profiles are assigned to one component 2 in each case and have an upper profile strip 5 and a lower profile strip 6 which have undercuts 7, into which, in the connected state, a connecting element 8 with undercuts complementary to the undercuts 7 is pushed. The embodiment shown here is exemplary and stands for a multiplicity of possible realisations with regards to the configuration of the profile strips 6, 7. Generally, connections of two components 2 of this type are realised without a connecting element 8. To this end, the first connecting profile 3 has undercuts 7 for example and the opposite connecting profile 4 has complementary undercuts 9, so that both components 2 can be inserted directly into one another. The embodiment shown here with one connecting element 8 has the advantage that both connecting profiles 3, 4 can be realised in an identical manner. Furthermore, in this manner, the components 2 themselves do not have to be displaced against each other for connection, rather the connecting element 8 merely has to be inserted.

FIG. 2 shows a first embodiment of the positive connecting device 1 for two components 2 in a connected perspective illustration. The upper and lower profile strips 5, 6 are respectively constructed herein in a plurality of individual profile segments 11 arranged with a spacing 10 from one another, the width a of the spacing 10 being at least equal to the width p of the profile segment 11. Further, each profile segment 11 of the upper profile strip 5 is arranged opposite a spacing 10 in the lower profile strip 6 and each profile segment 11 of the lower profile strip 6 is arranged opposite a spacing 10 in the upper profile strip 5, whereby in the projection view (see FIG. 3), in each case of the upper profile strip 3 to the lower profile strip 4, their profile segments 11 appear such that they lie next to one another without any overlap in a longitudinal direction of the connecting device. In the illustration, both connecting profiles 3, 4 are shown in the connected position, the connecting element 8 being indicated in a dashed manner. The width a of the spacing 10 corresponds at least to the width p of the profile segment 11, that is to say, the width a of the spacing 10 can also be larger than the width p of the profile segment 11, but in no way smaller. The construction of the profile strips 5, 6 in profile segments 11 with spacings 10 and their “staggered” arrangement is a prerequisite for a production of the connecting profile 3, 4 in a cost-effective plastic injection molding process with a simple divided mold without undercuts, the mold parting line of which is indicated and described in FIG. 9.

FIG. 3 shows a projection view from above onto the first connecting profile 3 from FIG. 2. In this case, the upper side 12 of the first connecting profile 3 with the upper profile strip 5 and two integrally formed profile segments 11 can be seen. They cover the spacings 10 of the lower profile strip 6 without any gaps. The covered undercuts 7 of the profile segments 11 of the upper profile strip 5 are indicated by means of dashed lines. The profile segments 11 with the solid lines of the lower profile strip 6, which illustrate the undercuts, can be seen through the spacings 11 of the upper profile strip 5. The orthogonal projection view shows a gapless arrangement of profile segments 11 and spacings 10 between the upper and lower profile strips 5, 6 in a longitudinal direction of the connecting device.

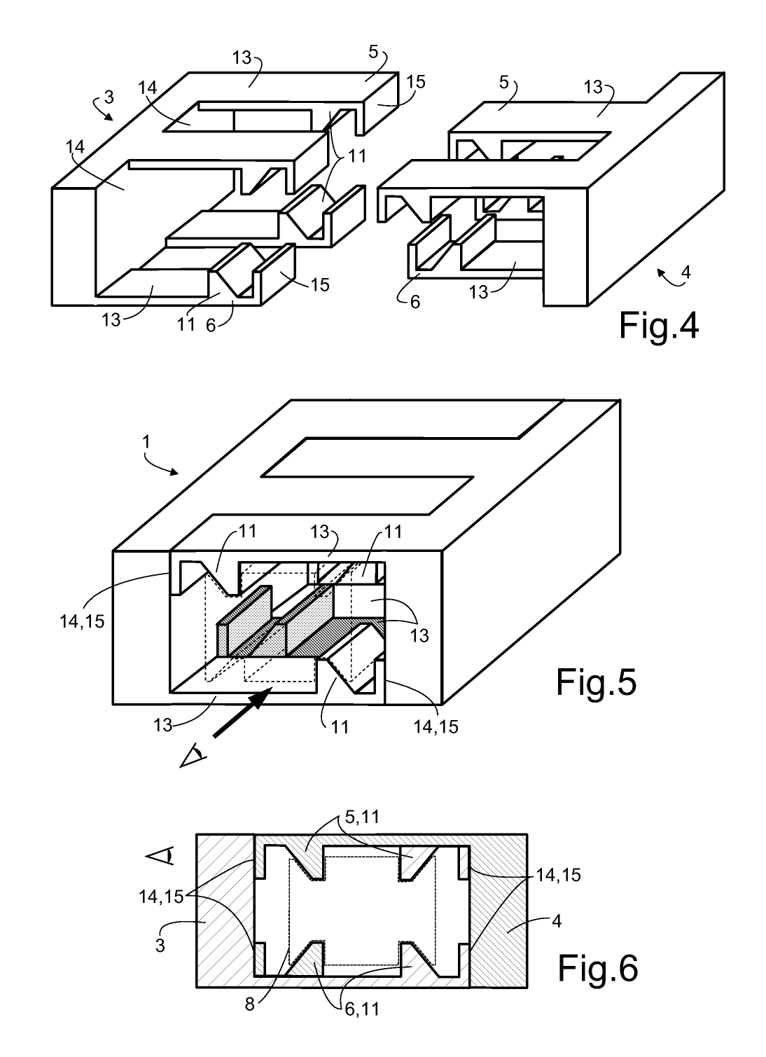

FIG. 4 shows another embodiment of the positive connecting device 1 for two components 2. In this embodiment, the profile segments 11 of the upper and lower profile strips 5, 6 of both connecting profiles 3, 4 are arranged on webs 13. For connecting both connecting profiles 3, 4, the profile segments 11 must be pushed into one another in a meshing manner at their webs 13. To this end, in addition to the overlap-free arrangement of the profile segments 11 which applies for both connecting profiles 3, 4 in the projection view from above, just such an overlap-free arrangement of the profile segments 11 is provided in the in the longitudinal direction of the connecting device from the sides of the connecting profiles 3, 4, so that the profile segments 11 do not penetrate one another at their webs 13. In this embodiment, the webs 13 are used for the particularly simple production of an exact spacing of the connecting profiles 3, 4 for pushing in the connecting element 8, in that both connecting profiles 3, 4 are pushed so far into one another that the profile segments touch a bearing surface 14 on the respectively opposite connecting profile 3, 4. Furthermore, to this end, the profile segments 11 can have end faces 15 in order to enlarge the bearing surface.

FIG. 5 shows the embodiment of the positive connecting device 1 for two components 2 from FIG. 4 in a connected perspective illustration. The profile segments 11 to some extent mutually cover themselves in this view at their webs 13 which lie next to one another starting from the two connecting profiles 3, 4 in a meshing manner and their end faces 15 touch the bearing surfaces 14. For better visibility, a profile segment 11 is colored grey at its web 13. In addition, the connecting element 8 is marked in a dashed manner.

FIG. 6 shows a projection view from the front onto the embodiment of the positive connecting device 1 for two components 2 from the FIGS. 4 and 5. In the case of orthogonal projection, the symmetrical profile of this embodiment is shown again. The connecting profiles 3, 4 are delimited in a meshed manner and their profile strips 5, 6 touch the bearing surfaces 14 on the respectively opposite side with the end faces 15 and thus form the exact distance for pushing in the connecting element 8.

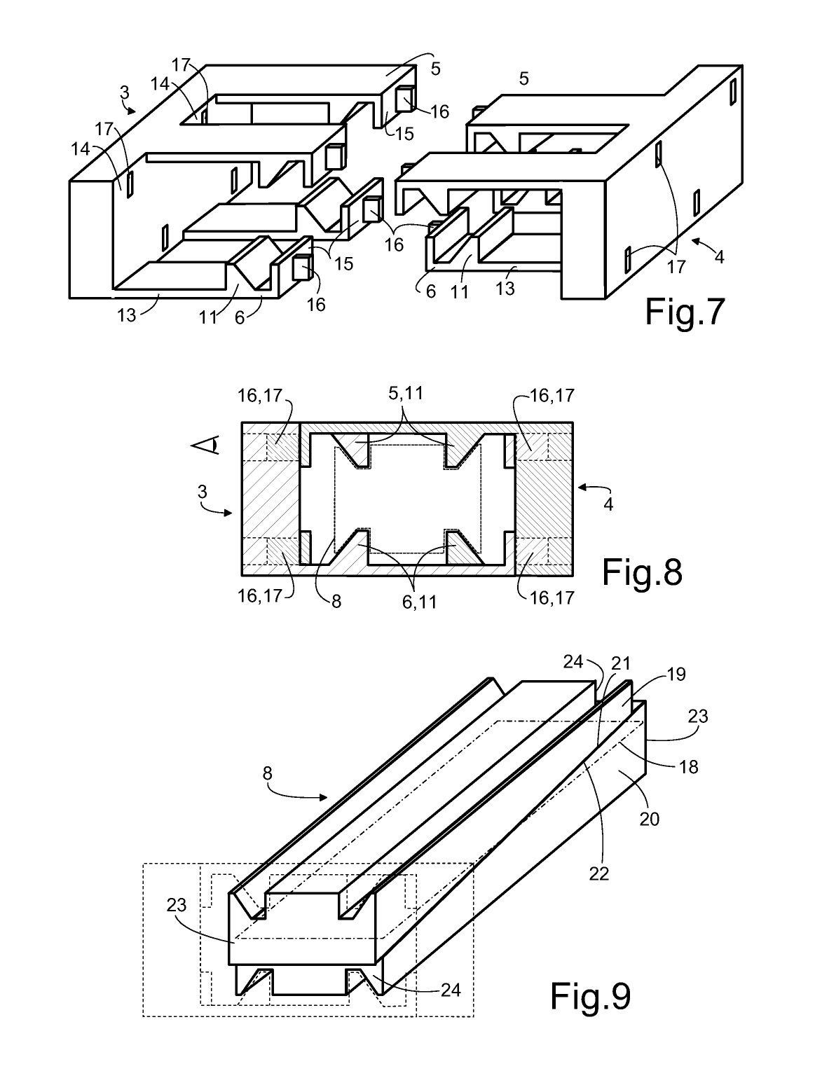

FIG. 7 shows a further embodiment of the positive connecting device 1 for two components 2 with profile segments 11 on webs 13. The end faces 15 of the profile segments 11 here have guide pins 16 which in the connected state engage into complementary accommodation openings 17 in the surface of the respectively opposite connecting profile 3, 4. The guide pins 16 essentially fulfill three tasks by means of a clean guiding of the profile segments 11 at their webs 13. First, any vertical offset of the connecting profiles 3, 4 with their attached components 2 is not allowed for, which would make the pushing in of the connecting element 8 more difficult. Second, by means of the guiding, a horizontal offset in the longitudinal direction of the connecting profiles 3, 4 is prevented, which horizontal offset could arise without the guide pins 16, if the width a of the spacings 10 is larger than the width p of the profile segments 11. As for example, by means of the omission of individual profile segments 11, the width a of the spacings 10 can be larger by a multiple than the width p of the profile segments 11, the offset in the longitudinal direction can be considerable and still change during the pushing in of the connecting element 8. The orderly image of the composite of the components 2 would therefore suffer or a complicated readjustment would always be required. Third, a widening of the connecting device 1 during the pushing in of the connecting element 8 is prevented. For a secure and play-free connection, the connecting element 8 must be held securely by the profile strips 5, 6 of the connecting elements 3, 4. This takes place by means of friction in this form of the connecting device 1. The profile segments 11 face the frictional pressure due to the connecting element 8 at their webs 13, which profile segments in this case deflect more or less upwards and downwards in accordance with their rigidity and therefore reduce the friction and the positive fit in the connecting device 1 to some extent. If, however, the guide pins 16 are guided into the accommodation openings 17, no more widening can take place, the friction is not reduced and the positive fit is retained completely.

FIG. 8 shows a projection view from the front onto an embodiment of the positive connecting device 1 for two components 2 with a transposition of the profile segments 11 with the webs 13. As the webs 13 only provide guidance with their guide pins 16 in this case and do not accommodate any substantial frictional force, they can also be realized in a narrower manner than the profile segments 11.

FIG. 9 shows a perspective view of the connecting element 8. The embodiment shown here has an oblique division into two symmetrically to a central dividing plane 18 in the longitudinal direction of the connecting device 1. Thus, an upper connecting body 19 and a lower connecting body 20 result, which have reverse sides 21, 22, which bear against one another, in the region of the dividing plane 18. The two connecting bodies 19, 20 are constructed such that their shape is identical due to the symmetrical dividing in two. Due to the oblique division in two, the mounting of the connecting element 8 is substantially facilitated. After the guiding together of the two connecting profiles 3, 4 into their connection position, the lower connecting body 20 can be guided into the lower profile strips 6 without the use of force with its thicker end 23 at the front. If, subsequently, the upper connecting body 19 is guided over the lower connecting body 20 into the upper profile strips 5 with its thinner end 24 at the front, this movement is possible without the use of force insofar as there is still play between the reverse sides 21, 22 of the connecting bodies 19, 20 and between these and the profile strips 5, 6. Only when all parts touch each other in the last part of the movement and growing friction arises, must a force be applied for the complete closing of the connecting device 1. In the case of a one-piece realization of the connecting element 8, a high friction would be applied over the entire movement path and a pushing in of the connecting element 8 would not be possible without a tool. The same is true in both cases for the releasing of the connection.

FIG. 10 shows a perspective illustration of the first connecting profile 3 of the positive connecting device 1 for two components 2 with a mold parting line 25. For easy removal of the undercuts 7 of the profile segments 11 from the mold, the mold can be divided into an upper and a lower mold part. If the division at planes I to V takes place along the mold parting line 25, the profile segments 11 of the upper profile strip 5 are molded by the lower mold part and the profile segments 11 of the lower profile strip 6 are molded by the upper mold part. When pulling off the mold parts upwardly in the direction of the upwardly directed arrows and downwardly in the direction of the downwardly directed arrows, there are no undercuts in the way. The division of the profile strips 5, 6 into profile segments 11 with spacings 10 and their overlap-free arrangement in the projection view from above is therefore provided for a simple production method as castings in a mold.

While the invention has been described with reference to particular embodiments thereof, it will be understood by those having ordinary skill the art that various changes may be made therein without departing from the scope and spirit of the invention. Further, the present invention is not limited to the embodiments described herein; reference should be had to the appended claims.

### LIST OF REFERENCE NUMERALS

1 Connecting device
2 Component
3 First connecting profile
4 Further connecting profile
5 Upper profile strip
6 Lower profile strip
7 Undercut
8 Connecting element
9 Complementary undercut
10 Spacing
11 Profile segment
12 Surface of 3
13 Web
14 Bearing surface
15 End face
16 Guide pin
17 Guide opening
18 Central dividing plane
19 Upper connecting body
20 Lower connecting body
21 Rear side of 19
22 Rear side of 20
23 Thicker end
24 Thinner end
25 Mold parting line

1. A positive connecting device for connecting components, the connecting device comprising:
a first connecting profile disposed on a first component and a second connecting profile disposed on a second component opposite the first connecting profile in a connected state of the connecting device, each connecting profile including an upper profile strip and a lower profile strip, each of the upper and lower profile strips including undercuts; and
a connecting element including undercuts that are complementary to the undercuts of the first and second connecting profiles when the connecting element is pressed between the first and second connecting profiles in the connected state of the connecting device,
wherein the upper and lower profile strips of the connecting profiles are configured as individual profile segments that are spaced apart from one another in a longitudinal direction of the connecting device with a spacing that is at least as wide as the profile segments such that the profile segments of the upper profile strips are disposed in a non-overlapping arrangement with the profile segments of the lower profile strips in the longitudinal direction.

2. The positive connecting device according to claim 1, wherein the first and second components are solar modules.

3. The positive connecting device according to claim 1, wherein the profile strips of the first connecting profile and the profile strips of the second connecting profile include a non-overlapping arrangement of the individual profile segments in the longitudinal direction in the connected state of the connecting device.

4. The positive connecting device according to claim 1, further comprising orthogonal webs of equal length disposed at least one of a rear side and a front side of the profile segments, the front side of the profile segments including an end face.

5. The positive connecting device according to claim 4, wherein the webs are configured as stops in the connected state of the connecting device so as to provide a spacing between the connecting profiles.

6. The positive connecting device according to claim 4, wherein a width of the webs is substantially equal to a width of profile segments.

7. The positive connecting device according to claim 4, wherein the webs include a one-piece construction with at least one of the profile segments and the connecting profiles.

8. The positive connecting device according to claim 1, wherein the first and second connecting profiles include a one-piece construction with the respective first and second components.

9. The positive connecting device according to claim 1, wherein an end face of the profile segments include a guide pin configured to engage in a guide opening disposed in a stop region on a respective one of connecting profiles in the connected state of the connecting device.

10. The positive connecting device according to claim 1, wherein at least one of the profile segments and the spacings have an equal width.

11. The positive connecting device according to claim 1, wherein the first and second connecting profiles are substantially identical in shape.

12. The positive connecting device according to claim 1, wherein the undercuts of the connecting profiles and the connecting element are configured as a double dovetail connection.

13. The positive connecting device according to claim 1, wherein the connecting element is divided into an upper connecting body and a lower connecting body in a region of a central dividing plane extending in the longitudinal direction of the connecting device, the upper and lower connecting bodies being configured to adjoin at reverse sides thereof along the dividing plane in the connected state of the connecting device.

14. The positive connecting device according to claim 13, wherein the dividing plane extends obliquely in the connecting device in the longitudinal direction.

15. The positive connecting device according to claim 13, wherein the upper and lower connecting bodies are substantially identical in shape.

16. The positive connecting device according to claim 1, wherein each end of the connecting element includes eyelets configured to guide tension cables.

17. The positive connecting device according to claim 1, wherein at least one of the connecting element and the connecting profiles include a hollow profile.

18. The positive connecting device according to claim 1, wherein at least one of the connecting element and the connecting profiles include injection-molded plastic.
